(19) United States
(12) Patent Application Publication
(10) Pub. No.: US 2026/0280747 A1
(43) Pub. Date: Sep. 17, 2026

(54) DEVICE FOR THE TAP-PROOF PLACEMENT OF A MOBILE TELEPHONE

(71) Applicant: GUARDIAN GMBH, Wien (AT)

(72) Inventor: Drazen MOKIC, Wien (AT)

(21) Appl. No.: 19/471,854

(22) PCT Filed: Feb. 13, 2024
(86) PCT No.: PCT/AT2024/060046

§ 371 Date: Oct. 2, 2025

(30) Foreign Application Priority Data
Apr. 3, 2023 (AT) A 50236/2023

(51) Int. Cl. H04K 3/00; H04M 1/04; H04M 1/19

(52) U.S. Cl. CPC H04K 3/825; H04K 3/68; H04M 1/04; H04M 1/19; H04K 2203/12

(57) ABSTRACT

The invention relates to a device (1) for the tap-proof placement of a mobile telephone (2), said device comprising a placement surface (6) and at least one ultrasonic emitter (3) for emitting an ultrasonic signal (4), wherein the ultrasonic emitter (3) is positioned below the placement surface (6) and is directed towards a deflection surface (7) which is designed in such a way that ultrasonic signals (4) emitted by the ultrasonic emitter (3) are deflected onto an area an or directly above the placement surface (6).

The present invention relates to a device for tap-proof storage of a mobile phone, comprising a storage surface and at least one ultrasonic emitter for emitting an ultrasonic signal.

In security-critical environments such as conference rooms, offices, or other confidential spaces, a particularly high level of secrecy is often desired. Since it is known, in particular, that mobile phones can be hacked by tapping the mobile phone's microphone, it is often desired that mobile phones be switched off during confidential conversations.

However, since switching off mobile phones is extremely time-consuming and all other functions of the mobile phone are deactivated as well, it is known from the prior art to sonicate the mobile phone's microphone. If the microphone is tapped by a third party in this case, conversations conducted near the mobile phone still cannot be overheard as they are overlaid by the sonication.

For example, a so-called “jammer” is known from WO2022040777A1, wherein a microphone is sonicated by an ultrasonic emitter, whereby tapping the microphone becomes impossible.

Jammers can essentially be divided into two categories. On the one hand, large-scale jammers that emit sound waves, especially ultrasonic waves, throughout an entire room can be used in order to thus disable as many microphones as possible. For example, one such jammer is offered by the company EO-Security under the name EO-3 PRO. It is indeed advantageous in this case that the mobile phones do not have to be oriented relative to the jammer, however, such jammers involve a number of disadvantages, such as, for example, the fact that the environment is unduly disturbed (e.g., even animals that are able to perceive ultrasound) or that it is not possible to specifically activate other microphones.

A second category of jammers employs a localized principle according to which mobile phones are placed in a box, which is then sealed. For example, one such jammer is offered by the company Pellta under the name Pellta One. Inside the box, the mobile phone is then sonicated, possibly even with sound waves in the audible range, so that the user knows that sonication is activated. What is considered advantageous about these jammers is that the cameras can be deactivated at the same time, since the box is closed.

However, jammers designed as boxes involve the disadvantage that the boxes have to be designed so as to be very bulky due to the space required by the ultrasonic emitters, and other functions of the mobile phones are also deactivated, since the box is closed, and, for example, the display is no longer visible. However, many users wish, for example, that it remains to be possible to visually determine whether a call is coming in. Examples of this are shown in the documents US 2016/098983 A1, US 2018/0277086, DE 10 2020 119 061 A1, and US 10,483,755 B1.

It is therefore the object of the present invention to provide a device for tap-proof storage of a mobile phone which overcomes the above-mentioned disadvantages.

This object is achieved by a device for tap-proof storage of a mobile phone, comprising a storage surface and at least one ultrasonic emitter for emitting a directional ultrasonic signal, with the ultrasonic emitter being arranged below the storage surface and being directed at a deflection surface designed such that ultrasonic signals emitted by the ultrasonic emitter are deflected onto an area on or directly above the storage surface. The term “area directly above the storage surface” is understood to mean that the ultrasonic signals can run in parallel to the storage surface directly above it.

This device can be designed to be particularly compact as the ultrasonic emitters are not arranged directly next to the storage surface, but rather below it, whereby a smaller overall width and overall length can be achieved. Furthermore, the deflection surface can be used to focus the ultrasonic signals emitted at a propagation angle β in order to sonicate the microphone more efficiently. As a result, the ultrasonic emitters can also be operated more efficiently and require less power.

Moreover, the device according to the invention has the advantage that mobile phones can be placed on the support surface without any further precautions to deactivate the microphone, and it is not necessary, in particular, to close the device with a lid. The display can thereby remain visible at all times. When a call comes in and the user wishes to talk, they can simply pick up the mobile phone from the storage surface and answer the call.

In a preferred embodiment, at least two ultrasonic emitters or two rows of ultrasonic emitters are provided, which are directed at opposite deflection surfaces, with both deflection surfaces being designed for deflecting the directional ultrasonic signals emitted by the respective ultrasonic emitter onto an area directly above the storage surface, the areas preferably facing the respective deflection surface. This involves the advantage that the user does not have to pay attention to which deflection surface the microphone is facing, and, respectively, the power of the ultrasonic emitters can be kept low, since it is known that the microphone will be located directly next to a sonicated deflection surface.

In a further preferred embodiment, at least two ultrasonic emitters are provided, which are designed for emitting essentially parallel ultrasonic signals so as to form a row of ultrasonic emitters, with the row of ultrasonic emitters being directed at the same deflection surface, and wherein, particularly preferably, two rows of ultrasonic emitters are provided which, in each case, are arranged in parallel, the two rows being arranged such that the respective ultrasonic emitters emit ultrasonic signals toward opposite deflection surfaces. Rows of ultrasonic emitters are particularly advantageous since the ultrasonic signals are usually emitted only at a small propagation angle, and the row of ultrasonic emitters enables planar sonication. Each ultrasonic emitter in a row is arranged at the same distance from the respective deflection surface, i.e., the rows and the deflection surfaces run essentially in parallel.

In some embodiments, the ultrasonic emitter can be directed, for example, vertically upwards. However, it is preferred if the ultrasonic emitter is arranged such that it emits ultrasonic signals at an angle of 30° to 60° relative to the storage surface. The advantage of this is that the ultrasonic emitter can be arranged directly below the support surface, but can still be arranged close enough to the deflection surface without the ultrasonic signals having to travel too great a distance.

In general, the deflection surface could have any shape, e.g., a flat shape, or it could emulate a discontinuous curve from flat sections that have been assembled. Preferably, however, the deflection surface is (continuously) curved, and, particularly preferably, it has a width that is greater than its height, with the width particularly preferably being substantially three times greater than the height. Tests have shown that, as a result, particularly good focusing of the ultrasonic signals can be achieved in the direction of the microphone.

Particularly preferably, the ultrasonic emitter and the deflection surface are arranged such that ultrasonic signals deflected by the deflection surface run essentially in parallel to the storage surface.

Furthermore, the device could comprise means for detecting a mobile phone on the storage surface, the means preferably consisting in a weight sensor or a light barrier, the means being designed for activating the ultrasonic emitter upon detection of a mobile phone on the storage surface. As a result, the user will not forget to switch on the device. This is advantageous especially for the present device, since there is actually no feedback from the ultrasonic signals that sonication is currently taking place. Furthermore, preferably and regardless of the automatic activation, the device could therefore also comprise an LED light which indicates whether the ultrasonic emitters are activated or whether a battery of the device is weak or empty. Furthermore, the device could comprise a loudspeaker which acoustically indicates the activation and/or deactivation of the ultrasonic emitters and/or a battery status (e.g., battery empty).

Furthermore, a gap is preferably provided between the deflection surface and the storage surface, which usually has a size of 1 mm to 10 mm. This is advantageous, on the one hand, to enable a deflection of the ultrasonic signals and, on the other hand, to not provide too large a space for the passage of unwanted objects.

Depending on the embodiment, the device could comprise a variety of elements. A device with as few components as possible comprises, for example, a base plate and a frame on which the deflection surfaces are formed, with the storage surface being arranged in parallel to the base plate at a predetermined distance.

To achieve a position of the mobile phone that is as predefined as possible, it is envisaged that the storage surface has at least one substantially rectangular section with a long side and a wide side, with the wide side being smaller than 11 cm and the long side being greater than 11 cm. For example, the wide side could have a length of between 8 and 10.5 cm, and the long side could have a length of between 16 cm and 25 cm. These dimensions force commercially available mobile phones into a predefined position. In this way, it is, in turn, made possible that ultrasonic emitters have to be provided only on one or two sides to achieve selective sonication of the microphone, or, respectively, rows of ultrasonic emitters can have shorter designs, as they have to be arranged only along the short wide side below the respective deflection surface.

Advantageous and non-limiting embodiments of the invention are explained in further detail below with reference to the drawings.

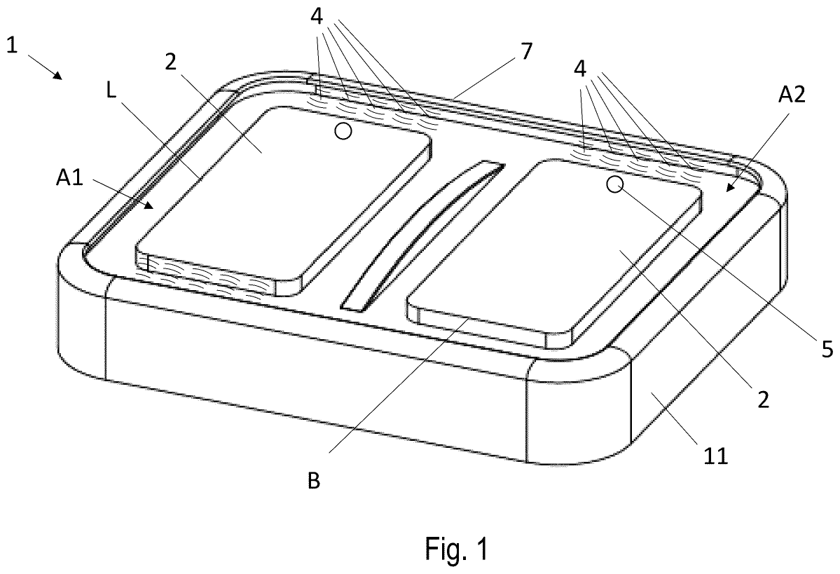

FIG. 1 shows the device according to the invention in a perspective view.

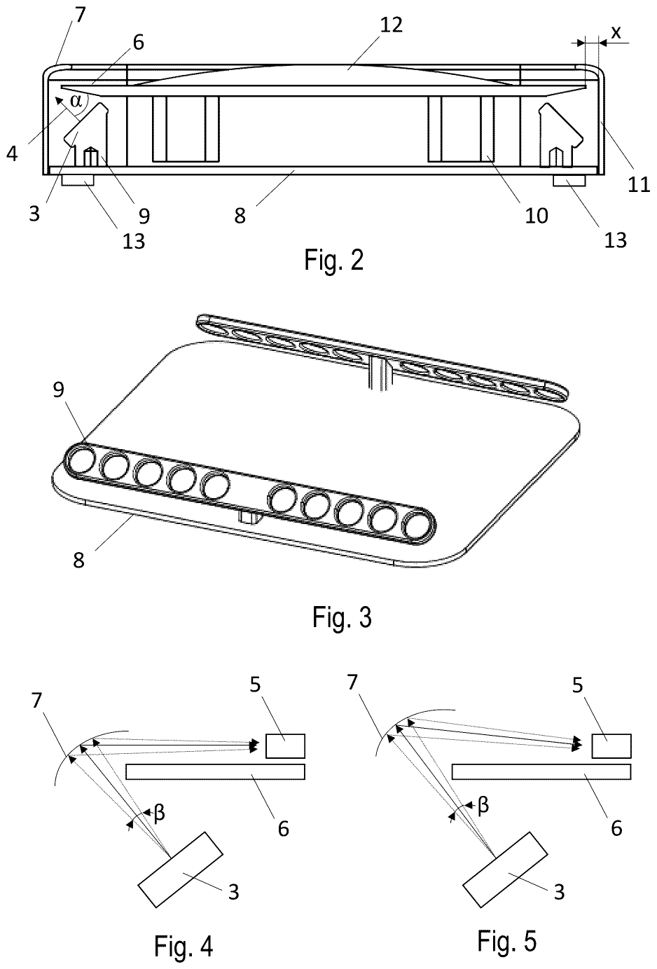

FIG. 2 shows the device of FIG. 1 in a sectional view.

FIG. 3 shows the base plate of the device of FIG. 1 in a perspective view.

FIG. 4 shows a first configuration for deflecting an ultrasonic signal in parallel to the storage surface.

FIG. 5 shows a second configuration for deflecting an ultrasonic signal onto the storage surface.

FIG. 1 shows a device 1 for tap-proof storage of mobile phones 2. To achieve this objective, the device 1 comprises ultrasonic emitters 3 (FIGS. 2 and 3) that emit ultrasonic signals 4.

Since the ultrasonic signals 4 in the present device 4 are directed at the microphone 5 of the mobile phone 2, the microphones 5 are no longer able to record ambient noise, such as conversations taking place in the vicinity of the device 1. Even if the mobile phone 2 is now hacked and the microphone 5 is tapped by an unauthorized person, it is not possible to listen in on the conversations.

The ultrasonic emitters 3 used in the present invention usually emit directional ultrasonic signals 4, which are emitted, for example, at a propagation angle β of approximately 15° (more generally 5° to 25°), see also FIGS. 4 and 5. Such ultrasonic emitters 3 are known per se and are used, for example, in automotive engineering for monitoring the immediate surroundings of the vehicle and for measuring distances to obstacles. A classic example of use is, for example, a parking aid for modern passenger vehicles.

In order to make the device 1 as compact and efficient as possible, it has a storage surface 6 on which the mobile phones 2 can be placed. The storage surface 6 is generally open at the top, i.e., it cannot be closed with a lid. As shown in FIGS. 2 and 3, the ultrasonic emitters 3 are not directed directly at the microphones 5 or, respectively, they are not directed directly at an area above the storage surface 6, but they are arranged below the storage surface 6 and they are directed at a deflection surface 7 in order to direct the ultrasonic signals 4 towards the microphone 5, which is located in an area directly above the storage surface 6. Due to this arrangement, even a low power of the ultrasonic emitters 3 is enough for sonicating the microphone in a tap-proof manner. The ultrasonic emitters 3 can be designed, for example, for outputting the ultrasonic signals 4 at substantially or up to 92 dB. Furthermore, the ultrasonic emitters 3 can be designed for outputting ultrasonic signals 4 only at frequencies above 20 kHz, since such sound waves are perceivable neither for humans nor for dogs or other animals which are usually located in the area where the device 1 is used. In general, however, the ultrasonic signals could also be outputted at frequencies above 16 kHz.

As shown, the ultrasonic emitters 3 are arranged at an angle a relative to the storage surface 6 which preferably corresponds to between 30° and 60°. However, the ultrasonic emitters could also be directed vertically upwards, for example. In the illustrated example, the angle a corresponds essentially to 45°.

The deflection surface 7 is designed such that the ultrasonic signals 4 emitted at the angle a are redirected in a direction that is located essentially in parallel to the storage surface 6. The resulting angle of the ultrasonic signals 4 after deflection can also be inclined relative to the plane of the storage surface 6, wherein the objective in all cases is to sonicate the microphone 5 in the best possible way. However, since the position of the microphone 5 is not predefined in a fixed manner, there is a certain amount of leeway in this case for variances and optimizations.

To achieve the above-mentioned deflection, the deflection surface 7 can, in the simplest case, have a flat design and can be arranged, for example, at an angle diametrically opposite to the ultrasonic emitter 3. However, as previously described, the ultrasonic emitters 3 emit the ultrasonic signals 4 at a certain propagation angle. This is schematically illustrated in FIGS. 4 and 5. To achieve proper focusing and localization of the ultrasonic signals 4 after deflection, the deflection surface 7 can also have a curved design, as is illustrated. The exact curvature of the deflection surface 7 is an optimization task that depends on the specific design of the device 1. In the present case, however, an elongated curve form has proved its worth, with the length of said form in a direction parallel to the storage surface 6 being greater, preferably three times greater, than its height in the direction normal to the storage surface 6. For example, the curved surface can have the shape of an elliptical or parabolic section.

Referring to FIG. 4, it is also evident that the ultrasonic signal 4 can be deflected in an area directly above the storage surface 6. In this case, the ultrasonic signal 4, i.e., its central axis, runs in parallel to the storage surface 6. It is evident that the ultrasonic signal 4 can be focused properly. FIG. 5 shows a different configuration of the deflection surface 7 so that the ultrasonic signal 4, i.e., its central axis, can be deflected onto an area on the storage surface 6, i.e., it is not deflected in parallel, but at an angle relative to the storage surface 6. Furthermore, it is evident that the ultrasonic emitter 3 and the storage surface 3 are arranged on the same side of the deflection surface 7.

As can be seen from the combined view of FIGS. 1 and 2, the deflection surface 7 is arranged along one or several sides of the device 1, simultaneously forming a circumferential upper edge of the device 1. For example, the support surface 6 can be rectangular, and sonicated deflection surfaces 7 could be provided on all four sides or only on two opposite sides of the support surface 6. Furthermore, it is evident from the combined view of FIGS. 1 and 3 that multiple ultrasonic emitters 7 can be directed at the same deflection surface 7. This is due to the fact that the ultrasonic signals 4 only have a certain propagation angle β so that multiple ultrasonic emitters 3 are arranged in series and in an essentially parallel emission direction in order to cover a larger planar area above the storage surface 6.

From FIG. 2, it is furthermore evident that a gap x is present between the storage surface 6 and the deflection surface 7, or more generally, a side wall of the device 1, in order to allow the passage of ultrasonic signals 4 at this point. The gap x has a size, viewed in the direction parallel to the storage surface 6, of preferably 2 mm to 10 mm, particularly preferably of 3 mm to 5 mm. While a small gap x is preferred to reduce contamination inside the device 10, a larger gap x promotes the passage of the ultrasonic signals 4. For the sake of completeness, it should be noted that a minimum distance between the storage surface and the deflection surface 7 exists also in the vertical direction, i.e., normally to the storage surface 6, in order to create a clear path for the ultrasonic signals 4 to an area directly above the storage surface 6.

The gap x is usually in a completely open state, but a sound-permeable material could also be spanned across it. This involves the advantage that no particles can penetrate into the space provided below the storage surface 6 for the ultrasonic emitters 4. However, the sound-permeable material would still allow the ultrasonic signals 4 to pass through.

In order to create the most compact device 1 possible, said device can comprise a base plate 8 on which the ultrasonic emitters 3 are arranged and, for example, screw-fastened, see FIG. 3. As is illustrated, the ultrasonic emitters 3 can be formed on a common support 9, on which several (specifically ten) ultrasonic emitters 3 can be arranged, as shown. Alternatively, all ultrasonic emitters 3 could be mounted on the base plate 8 as separate elements.

The storage surface 6 is provided above the base plate 8 and is kept at a predetermined distance above the base plate 8 by one or several supports 10. The supports 10 can be connected to the base plate 8 and/or to the storage surface 6 by means of screws or other fastening means. The supports 10 could also be formed integrally on the base plate 8 and/or on the storage surface 6.

As a further element, the device 1 comprises a circumferential frame 11 which forms the side walls and on the upper edge of which the deflection surface(s) 7 is/are formed.

The materials of the storage surface 6, the base plate 8 and the frame 11 can essentially be chosen arbitrarily, with plastic and metal being preferred. In initial tests, it has become apparent that metal and plastic are preferred for the deflection surface 7. However, sound-absorbing materials such as most textiles are preferably not used for the deflection surface.

It should be emphasized, however, that it is not absolutely necessary for the device 1 to be designed as an open box, as illustrated in FIG. 1. For example, a table with a recess in the tabletop could also be provided, wherein the upper edge of the recess can be designed like the deflection surface 7 shown in FIG. 2. The ultrasonic emitters 3 can then be inserted into this recess, and the storage surface 6 above them, in order to form the device 1. It will be understood that the device 1 could also be provided in other objects, while still achieving the above-mentioned functions.

Returning to FIG. 1, it is furthermore evident that a spacer 12 is provided on the storage surface 6. The purpose of the spacer 12 is to create two different sections A1, A2 for two different mobile phones 2 on the storage surface 6. Furthermore, the spacer 12 divides the sections A1, A2 by a predetermined size so that the mobile phones 2 can only be arranged along one orientation on the storage surface 6 and, in particular, a rotation of the mobile phone 5 by 90° is not possible, either. As a result, it is achieved that the microphone 5 of the mobile phone 2 faces a deflection surface 7. In other words, most mobile phones 2 have larger long sides L than wide sides B (FIG. 1). Typically, the long side L is greater than 11 cm, and the wide side is shorter than 11 cm. The spacer 12 causes the storage surface to be shortened, for example, to 11 cm so that the mobile phone 2 can be placed on the storage surface 6 only in one orientation.

In section A1, it can be seen that ultrasonic signals 4 are deflected by opposing deflection surfaces 7. For this purpose, ultrasonic emitters 3 are provided on opposite sides, as illustrated in FIG. 3. The two ultrasonic emitters 3 or, respectively, the two rows of ultrasonic emitters 3 thus emit ultrasonic signals 4 onto opposing deflection surfaces 7, whereby the ultrasonic signals 4 are each deflected onto an area directly above the storage surface. The areas are preferably facing the respective deflection surface 7 in order to reach a microphone 5 located there.

As a result, it is irrelevant whether the mobile phone 2 is rotated by 180°, which is advantageous as the user usually has no precise knowledge of the device 1.

For purposes of illustration, it is shown for the second section A2 that the ultrasonic signals 4 could also come from only one side, i.e., they could be deflected by only one deflection surface 7. On the one hand, the user could be aware of this and could position the mobile phone 2 such that the microphone 5 is arranged directly next to this deflection surface 7. On the other hand, the power of the ultrasonic emitters 3 could also be set so high that even a microphone 5 opposite the deflecting deflection surface 7 will be sonicated to such a strong extent that it cannot record any ambient noise.

For reasons of symmetry, however, it is usually envisaged that the configuration of the ultrasonic emitters 3 or, respectively, of the sonicated deflection surfaces 7 is symmetrical, i.e., in the embodiment of FIG. 1, both sections A1, A2 are designed equally, e.g., with sonication either from one side or from both sides.

In a further embodiment, which is not illustrated, the entire support surface 6 could be only as large as one of the sections A1, A2 shown and could have no spacer 12. In this case, too, one or two opposing deflection surfaces could be sonicated to achieve the above-mentioned effects, whereby the mobile phone 2 is still not rotatable by 90°.

However, in further embodiments, which are not illustrated, the storage surface 6 could also be designed in a square fashion and without a spacer 12, with deflection surfaces 7 sonicated by ultrasonic emitters 3, for example, being provided on all four sides of the square storage surface 6. In this case, the mobile phone 2 could be placed on the storage surface 6 in any orientation.

Furthermore, the device 1 can comprise a scale which serves the purpose of automatically switching on the ultrasonic emitters 3 when a mobile phone 2 is detected on the storage surface 6. For example, the scale can be designed for measuring a weight and for concluding on the presence of a mobile phone 2 when a weight threshold is exceeded. The weight threshold is, for example, 100 g. When the weight threshold is exceeded, the device 1 can automatically activate the ultrasonic emitters 3. In other words, the user cannot forget to switch on the device 1, whereby safety is increased.

On the one hand, it can be envisaged that the scale is designed for detecting that the device 1 or, respectively, the base plate 8 is lowered relative to a surface located below the device 1, e.g., if the scale is provided within feet 13 of the device 1. Alternatively, the scale could also be implemented in the support(s) 10, i.e., the scale could be designed for detecting that the storage surface 6 is lowered relative to the base plate 8. Using tilt sensors or two or several weight sensors, it would also be possible to determine on which section A1, A2 of the storage surface a mobile phone 2 is located in order to activate only the respective weight sensors.

As an alternative or in addition to the scale, a light barrier could also be used, which covers an area above the storage surface 6 to detect the presence of a mobile phone 2. The light source of the light barrier could be arranged, for example, at a point on the frame 11 that is not sonicated, or within the spacer 12.

To supply power to the ultrasonic emitters 3, the device can be connected to a power source and can comprise, for example, a plug connectable to a conventional power outlet. Alternatively, the device 1 could also comprise a battery, which, for example, could be designed such that the device 1 could have a net runtime of 2 to 10 days or of 3 to 4 days. What is meant by net runtime of the device 1 is that all ultrasonic emitters 3 run in continuous operation. Furthermore, two or more devices 1 could also be provided and connected to each other, with one of the devices 1 providing the power supply for the other devices 1.

1. A device for tap-proof storage of a mobile phone, comprising a storage surface and at least one ultrasonic emitter for emitting an ultrasonic signal, wherein the ultrasonic emitter is arranged below the storage surface and is directed at a deflection surface designed such that ultrasonic signals emitted by the ultrasonic emitter are deflected onto an area on or directly above the storage surface.

2. The device according to claim 1, wherein at least two ultrasonic emitters or two rows of ultrasonic emitters are provided, which are directed at opposite deflection surfaces, with both deflection surfaces being designed for deflecting the directional ultrasonic signals emitted by the respective ultrasonic emitter onto an area on or directly above the storage surface, the areas preferably facing the respective deflection surface.

3. The device according to claim 1, wherein at least two ultrasonic emitters are provided, which are designed for emitting essentially parallel ultrasonic signals so as to form a row of ultrasonic emitters with the row of ultrasonic emitters being directed at the same deflection surface, and wherein, particularly preferably, two rows of ultrasonic emitters are provided which, in each case, are arranged in parallel, the two rows being arranged such that the respective ultrasonic emitters emit ultrasonic signals toward opposite deflection surfaces.

4. The device according to claim 1, wherein the ultrasonic emitter is arranged such that it emits ultrasonic signals at an angle of 30° to 60° relative to the storage surface.

5. The device according to claim 1, wherein the deflection surface Aris curved and preferably has a width that is greater than its height, with the width particularly preferably being substantially three times greater than the height.

6. The device according to claim 1, wherein the ultrasonic emitter and the deflection surface are arranged such that ultrasonic signals deflected by the deflection surface run essentially in parallel to the storage surface.

7. The device according to claim 1, furthermore comprising means for detecting a mobile phone on the storage surface, the means preferably comprising a weight sensor or a light barrier, the means being designed for activating the ultrasonic emitter upon detection of a mobile phone on the storage surface.

8. The device according to claim 1, wherein a gap is provided between the deflection surface and the storage surface, which preferably has a size of 1 mm to 10 mm.

9. The device according to claim 1, comprising a base plate and a frame on which the deflection surfaces are formed, with the storage surface being arranged in parallel to the base plate at a predetermined distance.

10. The device according to claim 1, wherein the storage surface has at least one substantially rectangular section with a long side and a wide side, with the wide side being smaller than 11 cm and the long side being greater than 11 cm.
